(19) United States
(12) Patent Application Publication
(10) Pub. No.: US 2019/0066422 A1
(43) Pub. Date: Feb. 28, 2019

(54) MODULE UNIT COMPRISING AN INTERFACE FOR A COMMUNICATION DEVICE

(71) Applicant: Huf Hülsbeck & Fürst GmbH & Co. KG, Velbert (DE)

(72) Inventors: Jan BREER, Essen (DE); Marc FELDSIEPER, Hattingen (DE); Matthias IHLN, Düsseldorf (DE); Stefan NEUHOFF, Essen (DE); Mirko SCHINDLER, Velbert (DE); Thomas SKALETZ, Meerbusch (DE); Boris ZILLER, Ratingen (DE)

(21) Appl. No.: 16/080,026

(22) PCT Filed: Feb. 16, 2017
(86) PCT No.: PCT/EP2017/053546

§ 371 Date: Aug. 27, 2018

(30) Foreign Application Priority Data
Feb. 26, 2016 (DE) 10 2016 103 478.9

(51) Int. Cl. G07C 9/00; B60R 25/24; H04W 4/20

(52) U.S. Cl. CPC G07C 9/00309; B60R 25/24; G07C 2209/63; G07C 2009/00365; H04W 4/20

(57) ABSTRACT

The invention relates to a module unit (10) for adapting a mobile portable communication device (20) to a security system (1) of a vehicle (2), in particular for the keyless activation of an access system of the vehicle (2), with an interface (10.1) for the data exchange (30) with the communication device (20), and at least one communication unit (10.2) for the communication with the security system (1), wherein the module unit (10) is configured in such a way that the communication can be performed by a wideband communication method.

The present invention relates to a module unit for adapting a mobile portable communication device to a security system, in particular for the keyless activation of an access system of a vehicle according to claim 1. Furthermore, the invention relates to a module system, a security system as well as a method for adapting a mobile, portable communication device to a security system according to the respective preambles of the independent claims.

Mobile identification transmitters (ID transponders) are used as electronic keys in order to enable the unlocking of a security system of a vehicle as an alternative to mechanical keys. Furthermore, ID transponders can be used for numerous further applications in vehicles to increase user comfort and security. Infrared systems or radio systems in the low frequency (LF) range are usually employed for the communication of the ID transponder with the vehicle (or the security system of the vehicle). Authentication data can thereby be transmitted in a contactless (wireless) manner, and thereby the access data can be verified, for example, in order to enable an unlocking in the event of a positive authentication. The authentication can be initiated, for example, by the user by pushing a button. Through such an active actuation of the identification transmitter by the user, the signal with the authentication information, e.g. with the access data such as a code, is sent to a vehicle-onboard electronics of the security system. Such systems are also referred to as Active Keyless-Entry systems (if for example a button must be pushed actively). Besides the Active Keyless-Entry systems, security systems having the so-called Passive Keyless-Entry or Keyless-Go functions are used more and more. In contrast to the conventional remote control, an active actuation of the ID transponder (i.e. without pushing a button) by the user is not required in the Passive Keyless Entry functionality. For example, if a user approaches the vehicle, or actuates a door handle, a wake-up signal can be transmitted to the identification transmitter from the vehicle via a radio connection, in particular a Low Frequency (LF) radio connection. The ID transponder will be woken up thereupon, and sends a radio signal with the code for authentication to the security system of the vehicle.

It turned out to be a disadvantage here that only ID transponders or only those types of devices can be used for authentication that are capable of receiving signals via the radio connection of the security system and can thereupon sent a reply signal. The device, which is to serve as an ID transponder, thus must support the corresponding communication technologies of the security system of the vehicle. A user of the vehicle often already carries mobile, portable communication devices such as mobile phone or laptop with them, which would basically be suitable to generate codes for an authentication. However, these do often not comprise corresponding communication means (such as an LF receiver), in order to receive the wake-up signal via the radio connection, for example. Thus, a user must carry an ID transponder in addition to their mobile portable communication device, in order to perform an authentication process at the security system of the vehicle. Moreover, the ID transponder requires additional space, must contain expensive, complex electronics with communication interfaces, and affects security through a potential unauthorized use in the case of loss.

Thus, it is an object of the present invention to at least partially resolve the above described disadvantages. In particular, it is an object of the present invention to provide a cost-efficient, secure and/or reliable adaption of mobile portable communication devices to security systems, in particular for the keyless activation of an access system for vehicles. Thus, a separate ID transponder can be particularly dispensed with, costs can be saved, and security can be increased.

The above object is achieved by means of a module unit having the features of claim 1, a module system having the features of claim 9, a security system with the module system according to the invention as well as by a method having the features of claim 16. Further features and details of the invention result from the respective sub-claims, the description and the drawings. Features and details described in conjunction with the module unit according to the invention naturally also apply in conjunction with the module system according to the invention, the security system according to the invention, as well as the method according to the invention here, and vice versa, in each case, so that reference can always mutually be made to the individual aspects of the invention in regard to the disclosure.

The object is, in particular, achieved by means of a module unit for adapting a mobile portable communication device to a security system of a vehicle, in particular for the keyless activation of an access system of the vehicle, with an interface for the data exchange with the communication device, and at least one communication unit for (in particular ultra-wideband) communication with the security system, wherein the module unit and/or the communication unit is formed in such a way that the communication can be performed by means of a wideband communication method, preferably as a radio connection. The vehicle is, for example, a motor vehicle and/or a passenger car and/or a truck and/or an electric vehicle and/or a hybrid vehicle, wherein the security system can be activated, for example, via the radio connection by means of an ID transponder. The security system is preferably configured to transmit and/or receive security-relevant data, in particular for the authentication and/or distance determination, via a wideband communication method, in particular ultra-wideband.

The transmission of this data is effected, as the case may be, to an ID transponder, wherein this transponder supports a corresponding communication technology of the security system. The module unit according to the invention provides the advantage that an adaption of a communication device for the transmission and/or reception of the data of the security system is possible even though the communication device does not natively support the communication technology of the security system. e.g. a wideband communication method. The missing support of the communication technology can, for example, be traced back to the fact that the communication device does not comprise a communication interface for the relevant frequency range, or a communication is not released by the communication technology of the security system.

The security-relevant data of the security system include a wake-up-signal, for example. In this context, wake-up signals particularly concern signals with information that is suitable to trigger an authentication process with the security system and/or a distance determination and/or a communication process with the security system. The wake-up signal is transmitted via the wideband communication method, such as UWB, and/or via a further communication method, such as LF or HF, for example. The signals or information received from the module unit can be provided to the communication device via the interface, for example. Even though the communication device does not directly support the communication technology of the security system, i.e. e.g. a wideband communication method and/or LF or HF, a preferably indirect communication with the security system is thus nevertheless possible via the module unit. Thus, the module unit or the communication unit establishes the connection between the security system and the communication device. The advantage is that mobile, portable communication devices of different types can be adapted to a security system of any vehicle in a reliable, flexible and cost-efficient manner in this way, and the use of the mobile, portable communication devices as ID transponders is enabled in this way. A separate ID transmitter is thus no longer necessary, whereby space requirements and costs are reduced for the user.

It is preferably provided that a radio connection for the communication between the module unit and the vehicle with the wideband communication method, e.g. ultra-wideband, is used. The radio signals transmitted via the radio connection, in particular a wake-up signal, is an UWB signal in this case, for example. Communication via ultra-wideband technology is based upon the technical idea that the channel capacity increases linearly with the bandwidth of the transmitter signal and logarithmically with its power. The available bandwidth is narrow and constant in communication technologies such as Bluetooth, for example. By contrast, UWB uses a very wide frequency range to enable a high channel capacity at reduced transmission power. This provides the advantage that a data transmission can occur at a very low power consumption by the (UWB) transmitter. The maximum power output of a UWB transmitter (such as the communication unit) is 1 mW, for example.

In the scope of the invention, Bluetooth particularly also means Bluetooth Low Energy.

In particular, a multiplexing method, preferably a frequency multiplexing method such as an Orthogonal Frequency Division Multiplexing (OFDM) and/or a code multiplexing method such as a Code Division Multiple Access method, in particular a Direct-Sequence-Code Division Multiple Access (DS-CDMA) is employed for communication, in particular for the data transmission. Preferably, pulse-type signals are wirelessly transmitted for the transmission of data. Here, for example, a shifting of the pulses by means of (pseudo)random values is effected, wherein then (UWB) transmitters and (UWB) receivers consider the same values for the shift. Preferably, prior to or at the start of the transmission of data, a temporal synchronization of (UWB) transmitter and (UWB) receiver is effected. For the evaluation of the received signal, the (UWB) transmitter and/or the (UWB) receiver includes e.g. electronic components such as comparators for the comparison of received pulses and/or correlation receivers and/or integrated circuits and/or microprocessors and/or electronic components for performing a Fast Fourier Transformation.

The communication of the module unit with the vehicle and/or with the security system of the vehicle, in particular the data transmission of security-relevant data, in particular by means of UWB, preferably occurs in an encrypted manner. To that end, cryptographic security mechanisms such as RSA are preferably employed, which, for example, include connection keys and/or authentication mechanisms and/or the use of secret (private) and public keys and/or a symmetric and/or asymmetric cryptographic system and/or a hybrid encryption. This achieves the advantage that a secure and reliable transmission is possible.

The communication via the wideband communication method, preferably via UWB, is preferably effected via at least one large frequency range, preferably with a (total) bandwidth of (at least) 500 MHz to 900 MHz and/or (at least) 3.5 GHz to 10 GHz and/or at least 5 GHz and/or at least 2 GHz and/or at least 1 GHz and/or at least 500 MHz and/or at least 40% and/or at least 30% and/or at least 20% and/or at least 10% of the arithmetic mean value of the lower and upper limit frequency of the used frequency band. For example, the frequency range in the range from 0 to 40 GHz, in particular 500 MHz to 900 MHz, preferably 3.5 GHz to 10 GHz, preferably 3.5 GHz to 6.8 GHz, preferably 20 MHz to 11 GHz, particularly preferably 30 MHz to 10.6 GHz, and/or 22.0 GHz to 26.7 GHz and/or 1 MHz to 12.4 GHz and/or essentially 700 MHz can be used. Furthermore, it can be provided that the maximum mean value of the spectral power density for the (UWB) communication is in the range between −90.0 dBm/MHz and −20.0 dBm/MHz, preferably maximal −41.3 dBm/MHz. The data transmission rate for the data transmission is preferably at least 1 Mbit/s or at least 4 Mbit/s or at least 6 Mbit/s, in particular no more than 6.8 Mbit/s or 10 Mbit/s. Thus, a quick and interference-proof transmission is possible.

It can further be provided that according to the UWB communication, also the distance determination is effected by means of a distance measurement such as a time of flight analysis of a (UWB) signal. In particular, a frequency range from 22.0 GHz to 26.6 GHz can be used here.

Furthermore, it can be possible in the scope of the invention that the module unit according to the invention receives a signal from the vehicle (e.g. from the onboard security system) via a radio connection, and preferably is or can be connected to the communication device such that the signal received via the radio connection by the module unit, in particular a wake-up signal, can be evaluated by the communication device. It is conceivable here that the radio connection is a first radio connection of a first radio connection (such as a UWB radio connection) of a first communication unit and/or a second radio connection (such as a LF and/or HF radio connection) of a second communication unit. In particular, the module unit and/or the communication device can be woken because of the reception of the signal. In this case, waking particularly relates to the activation of functions and/or components of the module unit or the communication device or also the change from a sleep mode to the operating mode, e.g. with a higher energy consumption. It can be provided here that the (wake-up) signal can be evaluated by the module unit via the in particular wireless data connection from the communication device. The (wake-up) signal can, in particular, trigger communication of the communication device and/or the module unit with the security system. Here, the vehicle-sided security system can comprise an access system (e.g. central locking mechanism for the vehicle doors), which has Active-Keyless-Entry, Passive-Keyless-Entry or Keyless-Go functionality. The security system serves for example for the keyless activation of an access system for vehicles, in particular motor vehicles. To that end, in particular an authentication process and/or a distance determination (with positive result) initiated by the (wake-up) signal or following the reception of the (wake-up) signal is required for activation. The positive result relates, for example, to a successful code verification and/or code conformance in the authentication and/or a distance of the module unit to the vehicle determined by the distance determination, which has to be less than a maximum distance. The authentication process allows activating functions of the security system of the vehicle, e.g. an opening or closing of a closing device of the vehicle, e.g. also doors and lids in the rear and/or side region of the vehicle, a starting of the engine/motor or an activation or deactivation of the immobilizer system.

The (wake-up) signal is sent, for example, by at least one onboard communication module of the security system. To that end, antennas can be provided in different areas of the vehicle, e.g. outside the vehicle, in the interior space, at the doors, in particular door handles, on the roof, the rear side, and/or the side region of the vehicle, or in the trunk. In the event that the (wake-up) signal is transmitted via an UWB and/or LF radio frequency, the range is strongly limited and is also strongly attenuated by the vehicle body and/or (completely) shielded-off. This e.g. also allows a distance determination. This also allows that a device receiving the (wake-up) signal (e.g. an ID transponder or the module unit) can be localized inside or outside the vehicle, and preferably the localization inside the vehicle can be discriminated from the localization outside the vehicle. As a support, it is also possible that another method for distance determination is used, such as an evaluation of the signal strength or signal transit time (“Time-of-Flight”). After the localization and/or the reception of the signals and/or the distance determination (in a positive result), e.g. an authentication process is initiated, which particularly includes the transmitting of a reply signal to the security system, wherein the reply signal can contain a code (access code) for identification verification. The reply signal is received and evaluated e.g. by the onboard communication module or by another onboard electronics. Preferably, a UWB and/or LF antenna which is capable of receiving the (wake-up) signal from the vehicle is provided in the module unit, in particular in a communication device of the module unit and/or the (first and/or second) communication unit. An antenna of the module unit, e.g. a UWB and/or LF antenna, can be provided for the reception, and a separate or the same antenna can be provided for the transmission of signals.

The module unit according to the invention particularly serves to adapt the communication device to the vehicle-onboard security system, in order that the communication device can indirectly (by the module unit) receive the wake-up signal and/or further signals of the radio connection. The module unit can be configured, for example, in such a way that an electronics unit or change unit is provided, and that the (first and/or second and/or further) communication unit is connected to the interface via the electronics unit or the change unit in such a way, in particular electronically, that a (wake-up) signal received via radio is adapted for the communication signal and forwarded to the interface. The electronics unit can, for example, comprise a microprocessor with a program sequence, which adjusts the (wake-up) signal for the communication device (e.g. a conversion into a data format), and forwards it. In this way, the electronics unit can, in particular, initiate a data exchange for the transmission of the wake-up information with the communication device. It is particularly conceivable that the (wake-up) signal is exclusively receivable via the radio connection and exclusively emitted via radio by the vehicle-onboard communication module. In addition, it is conceivable for the communication between the module unit and the vehicle onboard security system and with the vehicle, that a first radio connection of a first frequency band, in particular an UWB frequency band, is used and, a second or further radio connection or a second or further frequency band is provided for the communication between the communication unit and the communication device, wherein the first frequency band and the second (or further) frequency band are different from one another. Preferably, the first frequency band is larger than the second (or further) frequency band, and particularly preferably has at least twice or three times or four times the width of the second (or further) frequency band. This provides the advantage that two different frequency bands with different properties (e.g. a small range for the wake-up signal) can be used.

Furthermore, it can be provided in the scope of the invention that the communication unit is configured as a first communication unit for the communication by the wideband communication method, and preferably is configured as an ultra-wideband communication unit, and preferably at least a second communication unit is provided, which preferably is configured as a LF and/or HF communication unit. Furthermore, it is conceivable that a communication device of the module unit is provided, which comprises e.g. the first and/or a second and/or at least one further communication unit.

The communication units can, in this case, each support different communication technologies (e.g. of the security system). Thus, the first communication unit as a UWB communication unit can enable e.g. communication via UWB, and the second communication unit can enable communication via LF and/or HF as an LF and/or HF communication unit. Further communication technologies can e.g. also be Bluetooth, in particular Bluetooth Low Energy, which are supported by the first and/or second and/or further communication unit. The communication units can each comprise corresponding antennas to that end. Thus, a versatile use of the module unit is possible.

Advantageously, it can be provided in the invention that a wake-up signal of the vehicle, preferably a Bluetooth (i.e. also Bluetooth Low Energy) and/or an ultra-wideband and/or LF and/or HF wake-up signal, in particular a vehicle-side emitted wake-up signal, can be received by the module unit and/or a communication device, in particular the first or second communication unit. Here, the communication unit may comprise at least one antenna, in particular a UWB and/or HF and/or LF antenna, in order to receive the wake-up signal via the radio connection. Preferably, it can be possible that UWB signals and/or HF (High Frequency, i.e. shortwave) signals and/or UHF (Ultra High Frequency, i.e. ultra-high-frequency) signals are transmitted through the radio connection. Dependent on the corresponding radio connection, the module unit may comprise at least one UWB, Bluetooth, LF, UHF and/or HF antenna. The antenna includes e.g. an antenna coil with or without ferrite core, a powder core, or other ferromagnetic substances. Just as well, a print antenna (antenna printed on a circuit board), a patch antenna or a Planar Inverted F-Shaped (PIF) antenna can be used, which can, in particularly directly, be integrated in the circuit board, and may comprise a wound antenna or a 3D antenna for a position-independent read-out, for example. As a result, a space-saving arrangement of the antenna and, independently of the orientation of the module unit, a sufficient reception is ensured. In addition, the range, e.g. of the reception of the wake-up signals, can be reduced by the use of UWB and/or LF signals, in order to prevent an unauthorized interception of the signal.

Further advantageously, the module unit according to the invention can be configured in such a way that the module unit changes (in particular by a change unit) from a resting state to an operating state upon reception of a wake-up signal (and/or further signal via the radio connection), and preferably a data exchange of the interface with the communication device is triggered during and/or after this transition or change from the resting state to the operating state. The data exchange is triggered by an electronics unit or the change unit, for example. Here, the resting state can be distinguished by a lower energy consumption than in the operating state, since individual components such as the first communication unit of the module unit and/or of the communication device can be in the stand-by mode and/or be turned-off in the resting state, for example. For example, operation of the interface for data exchange is not necessarily required in the resting state. Since, as the case may be, a data exchange and/or a distance determination must occur after the receipt of the wake-up signal, components of the module unit and/or of the communication device can be activated in the operating state and thus a higher energy consumption can be required.

It can be optionally provided here that upon reception of the wake-up signal from the module unit, a data exchange to the communication device is triggered for the transmission of information via the wake-up signal. Likewise, it can be possible that the data exchange serves for the control of functions of the communication device and/or of the communication of the module unit with the security system via the communication device. Preferably, the data exchange can, in addition, be used to send signals, from the communication device, via the module unit or the communication device to the security system. The advantage is that communication technologies supported by the module unit can also be used by the communication device and vice versa.

It can be of further advantage if the data exchange takes place bidirectionally or unidirectionally. As a result, data can be sent from the communication device to the module unit, and vice versa. In addition, the radio connection can also be bidirectionally or unidirectionally, i.e. the communication unit may comprise e.g. an exclusive reception unit, or likewise a transceiver unit. For the evaluation of the wake-up signal by the communication device, it can additionally be provided that the communication device merely retrieves registers or data in at least one storage of the module unit. This retrieval can be done in a cyclic manner, for example, in order to detect the receipt of the wake-up signal. Just as well, an evaluation by means of the communication device can be triggered in the sense of an interrupt control by the reception of the wake-up signal. Thus, information can reliably be transmitted through the wake-up signal from the vehicle onboard security system via the module unit to the communication device.

It is also conceivable that the module unit first receives a Bluetooth and/or LF and/or HF signal (from the vehicle or the security system), e.g. via a second communication unit, and as a reply to the reception of the Bluetooth and/or LF and/or HF signal, a UWB signal is sent to the security system and/or to the vehicle via a first communication unit through a UWB radio connection. Subsequently, preferably the security system and/or the vehicle can send a (UWB) reply signal to the module unit via the UWB radio connection. In particular, subsequently, for the distance determination, an evaluation of the temporal duration between the sending of the UWB signal to the vehicle and the reception of the reply signal by the module unit can be performed in order to determine the time-of-flight and thus the distance between the vehicle and the module unit. This corresponds, for example, to a distance determination for determining a distance information about the distance, wherein the distance information can be evaluated by the module unit and/or by the security system and/or by the vehicle and/or by the communication device. Depending upon this evaluation, an authentication process, for example, can be triggered subsequently, preferably by the module unit, in particular only in the event that the determined distance is less than a predefined maximum distance. This provides the advantage that a secure distance determination (e.g. by the module unit) can be effected, in order to enable, for example, a secure authentication. Prior to the activation of the first communication unit and/or the sending of the wake-up signal and/or based on the wake-up signal, a pre-authentication of the module unit by the security system is enabled, for example, in order to check the authorization of the module unit. Furthermore, it is conceivable that the waiting period until the receipt of the reply signal is limited by the module unit, and thus the first communication unit is deactivated after a predetermined time period, for example, without that an evaluation of the reply signal or of the temporal duration has occurred. This can additionally save energy. The predetermined time period depends, for example on the maximum distance and/or the propagation speed of the signal via the radio connection.

It can further be provided in the scope of the invention that the module unit according to the invention comprises a change unit and/or electronics unit for the evaluation of received signals, preferably radio signals, in particular from the vehicle, which are connected to the interface and/or the (first and/or second) communication unit and/or the electronics unit in such a way that the change unit and/or the electronics unit carries out a transition from a resting state to an operating state upon reception of a radio and/or wake-up signal. This is enabled, for example, in that the change unit and/or electronics unit, the interface and/or the (first and/or second) communication unit are directly and/or indirectly connected to one another via conductor paths on a circuit board. The change unit and/or electronics unit can comprise, for example, at least one microprocessor, in particular also with storages and registers. It is conceivable that the storage contains a program sequence for performing the method according to the invention, and/or the storage can be read by the microprocessor. Likewise, a control of the antenna by the communication unit can be possible. The module unit can additionally comprise further electronic components such as LEDs, displays or other indicating elements, which are controlled via the microprocessor and for example indicate, to the user, a reception of a wake-up signal, the operating state and/or a connection with the communication device. Thus, these indicating elements support a simple operation of the module unit for a user. The wake-up signal can, for example, be a UWB signal and/or LF signal and/or HF signal and/or Bluetooth signal, which is received by the first or second communication unit. In the scope of the invention, Bluetooth also means Bluetooth Low Energy (Bluetooth Low Power).

Advantageously, it can be provided that the module unit is configured in such a way that upon or after reception of a first and/or second and/or further communication unit, in particular of a wake-up signal, a data exchange of the interface with the communication device is initiated. In this way, the communication device can be woken up and/or the wake-up signal can be provided to the communication device. It is to be noted here that the module unit can likewise be configured only for the exclusive reception of the vehicle wake-up signal, so that after the reception of the vehicle-sided wake-up signal, whereby also the communication device is woken up, the further communication (e.g. for authentication) takes place exclusively between the communication device and the vehicle, in particular the security system.

According to an advantageous development of the invention, the module unit according to the invention can be configured in such a way that data with information about a state of the module unit can be transmitted to the communication device through the data exchange of the interface, and in particular the data is generated by an electronics unit, wherein first data is generated in the resting state and/or second data is generated in the operating state. Thus, first data can contain information about the resting state and second data can contain information about the operating state. By the in particular wireless data exchange, the communication device can be informed about whether a change to a state (resting state or operating state) took place and whether the communication device must be ready for transmission or reception, for example. At the same time, it is conceivable that first and/or second data additionally contain information about the wake-up signal or about the charging state of an energy store. Likewise, it can be possible that first and/or second data include vehicle parameters, information about the operation of the module unit and/or of the communication device (e.g. the maximum range of the wake-up signal or of the operating mode) to the communication device. In this way, a user could request, using the communication device, e.g. information about the vehicle and/or the security system and control functions of the vehicle and/or of the security system.

Furthermore, it is conceivable that an authentication process can be triggered by an electronics unit and/or a change from an operating state to a resting state can be triggered by a change unit according to a certain scheme, in particular after lapse of a predefined time and/or after non-appearance of a (UWB) signal and/or wake-up signal, preferably in a distance determination (e.g. via UWB). To that end, e.g. a timer unit or a counter unit can be provided, which transmits time and/or or event information to the electronics unit and/or the change unit. The scheme can, for example, be preset in an unchangeable manner or be set by the user, e.g. by a software of the communication device. The authentication process and/or the change can take place automatically and/or manually e.g. by the push of a button by the user. Likewise, it can be provided that the resting state is activated in the event of a non-appearance of the UWB signal and/or wake-up signal, since an authentication is no longer necessary in this case. In this way, energy can be saved, for example, in the module unit and/or the communication device.

It is further conceivable that the interface, in a first transition from a resting state to an operating state, emits a signal for waking the communication device and/or for triggering an authentication process, and in particular in a second transition from the operating state to the resting state emits a signal for changing into the energy-saving mode and/or for terminating the authentication process. It can also be provided that the module unit comprises an energy store for the energy supply of the module unit and/or of the interface and/or of the communication device, wherein the energy supply of the module unit and/or of the interface is lowered in the resting state, and is essentially fully established in the operating state. Through the use of the wake-up signal to change from the resting state to the operating state, the service life of the energy store can be extended by the energy savings in the energy-saving mode.

Furthermore, in the scope of the invention, it can be possible that the module unit is free of an energy store, and is, in particular for the energy supply of the module unit, supplied with energy by the interface or by the communication device. As used herein, energy store particularly concerns an energy store configured as a primary cell, battery and/or accumulator. However, by contrast, it can nevertheless be provided that the module unit comprises a short-term storage, e.g. a capacitor, in order to take-up energy at short term and ensure a short-term energy supply.

According to the invention, it can also be provided that energy is transmitted onto the module unit from an energy transmission unit (e.g. the vehicle-sided communication module) of the vehicle or security system. The transmitted energy can, in particular, be received by the communication device and/or communication unit and/or a coil of the module unit and/or the interface of the module unit and serve for the energy supply and/or charging of an energy store of the module unit and/or of the communication device. Thus, energy from the vehicle transmitted via the LF or another radio connection or inductively can be used for charging the communication device, if the accumulator of the communication device is discharged. To that end, the energy transmitted to the module unit is transmitted to the communication device e.g. via the interface. In addition, an energy transponder can be provided in the module unit according to the invention, in order to supply this unit and, as the case may be, the communication device with energy.

Furthermore, it can be provided that, in a resting state of the module unit, a (first) communication unit, in particular a UWB communication unit, is deactivated for UWB or wideband communication (e.g. is in an energy-saving mode), and/or the (first) communication unit is being activated or can be activated in or during a transition of the module unit from the resting state to the operating state. This results in that a UWB communication (or a communication according to a wide-band communication method) of the module unit can be performed in an energy-saving manner only in the operating state. A second communication unit, in particular a LF and/or HF communication unit, is preferably activated both in the resting state and in the operating state. In this way, the LF and/or HF and/or Bluetooth communication of the second communication unit can serve to initiate the UWB communication or wideband communication. As a result, an additional energy-saving is possible while operating the module unit.

It is conceivable, in the scope of the invention, that the interface of the module unit for data exchange and/or the communication device support a first communication technology, which is different from a second communication technology of the communication unit for receiving the wake-up signal. Communication technologies in particular relate to Bluetooth connections according to the IEEE 802.15.1 standard in the frequency range of essentially 2.4 GHz, NFC (Near Field Communication) connections in the frequency range of e.g. essentially 13.56 MHz, infrared connections, GSM (Global System for mobile Communication) connections in the range of e.g. essentially 900 MHz, LTE (Long Term Evolution) connections in the frequency range of essentially 800 to 2600 MHz, UMTS (Universal Mobile Communication System) connections in the frequency range of essentially 0.8 to 2.2 GHz, or other mobile radio technology. Moreover, further radio connections such as HF, UHF, or LF radio connections or WLAN (Wireless Local Area Network) in the frequency range of essentially 2.4 to 5.8 GHz can be provided as a communication technology. Likewise, a wired communication technology such as USB (Universal Serial Bus) and/or other data interfaces are conceivable e.g. for the data exchange between the module unit and the communication device. Thus, it is possible to flexibly use the communication technology supported by the communication device and to dispense with a separate ID transponder.

Advantageously, in the module unit according to the invention, the interface may comprise a first transceiver unit, which is configured in such a way that a data exchange with the communication device can be realized by means of a radio and/or cable connection, in particular a UWB, Bluetooth, NFC, Infrared, GSM, LTE, UMTS, Mobile radio, HF, UHF, LF, WLAN and/or USB connection. The interface can comprise, for example, a first transceiver unit and an antenna, which is suitable for a data exchange by means of the respective communication technology. Likewise, it can be provided that the first transceiver unit is a, in particular exclusive, UWB, Bluetooth, NFC, Infrared, GSM, LTE, UMTS, mobile radio, HF, UHF, LF, WLAN and/or USB interface. Use of the WLAN, Bluetooth and/or mobile radio technology has the advantage that these technologies are supported by most communication devices.

Another advantage can be achieved, in the scope of the invention, when the module unit is formed as a backpack for the communication device, preferably as a battery case lid, memory card, SD card, mobile cover, mobile phone shell, attachment, plug and/or accumulator, and in particular comprises a plug connection and/or radio connection for the data exchange with the communication device. By forming it as a backpack, the module unit according to the invention can be connected to and/or integrated into the communication device in a very simple manner and thus assumes the role of an ID transponder for a security system in a vehicle. Here, original parts of the communication device such as battery lid, mobile phone shell or accumulators or the like can be replaced by the module unit, which is configured in accordance with the invention. This allows a particularly simple adaption or even integration to the communication device. A backpack particularly means a formation of the module unit that allows attaching the module unit to the communication device in such a way that the communication device can be handled and/or carried together with the module unit.

Furthermore, it is conceivable that an in particular strictly mechanical coupling means for the mechanical connection of the module unit with the communication device is provided, and the coupling means in particular has an exclusively mechanical holding function. The coupling means may comprise e.g. clips, screws, adhesives, hooks, or other mechanical connection elements (also in combination) for the, in particular form-fit, connection with the communication device. In order to ensure a simple handling as well as mobility of the module unit and/or of the module system according to the invention, in particular the module unit should be adapted to the external shape of the communication device in such a way that a simple and customary handling of the communication device is still possible. In particular, it can be provided that the module unit is attached on the communication device in a manner to be releasable by the user in such a way, that a transport and/or attachment of the module unit on the communication device are possible without further tools. In the case that the module unit is used e.g. for adapting a portable mobile communication device which is usually worn by the user, e.g. a smartphone, an additional wearing or carrying of a separate ID transponder for the security system can be dispensed with. In this way, both the comfort and the security can be increased, since a loss of a separate ID transponder is prevented. Moreover, even the functionality of the standard ID transponder can be improved significantly, since e.g. a display of the communication device can be used in order to have vehicle-onboard information such as tank filling level, tire pressure, maintenance interval and the like directly displayed, actually even outside the car, since the information data can be transmitted from the vehicle to the communication device through the provided data connections.

Furthermore, it can advantageously be provided in the invention that the module unit comprises at least one energy store to supply the communication device with energy from the energy store via a radio and/or cable connection, and/or that the module unit is supplied with energy by the communication device through the radio and/or cable connection. In the case that the communication device, e.g. a smartphone, is supplied with energy via the radio and/or cable connection by the module unit, this can be an emergency energy supply, e.g. of a further emergency energy store of the module unit. It is ensured here that an activation of the security system is still possible even with an empty energy store from the communication device and/or the module unit. On the other hand, e.g. the module unit can also be supplied with energy by the communication device, in order to ensure a simpler construction of the module unit without its own energy source.

Advantageously, it can be provided in the invention that the module unit comprises a monitoring unit in order to monitor the energy supply of the communication device and/or of the module unit, and the monitoring unit connects an energy store for the energy supply especially in the event of insufficient energy supply. Thus, the monitoring unit serves for maintaining a reliable functioning of the module unit and/or of the communication device in order to always enable an activation of the vehicle-onboard security system. The determination of the charging state can for example be effected by measuring the terminal voltage of the energy store, e.g. through a measuring unit of the monitoring unit. A low energy state can be present below 10%, below 5%, or below 1% of the maximum charging state, for example. Alternatively or additionally, it is conceivable that the monitoring unit deactivates the first and/or second and/or further communication unit of the communication device of the module unit in the event of an insufficient energy supply.

Furthermore, according to the invention, it can be provided that the module unit comprises at least one data storage in order to in particular exchange and/or store data via a radio and/or cable connection with the communication device. The data storage can contain, for example, the program sequence for carrying out the method according to the invention. Likewise, the data storage may contain a program sequence (i.e. a software and/or an app (application) for in particular a smartphone), which is suitable to be executed by the communication device. Just as well, the program sequence may contain in particular the steps for performing the authentication process and/or the codes for authentication e.g. in an encrypted manner. The program sequence is executed by the communication device, for example, and thus enables the use of the communication device as an ID transponder in connection with the module unit. This provides the advantage that for the adaption and for the extension of functions of the communication device, the software and/or the codes do not have to be provided via an external data storage, but instead are directly available upon connection of the module unit with the communication device. Since it may be possible that the codes are exclusively stored in the module unit, and are only retrieved by the communication device one by one, security can significantly be improved thereby here.

Advantageously, it can be provided in the scope of the invention that the module unit comprises a housing, wherein the interface, the communication unit, a (UWB) antenna, the change unit, the monitoring unit, the transponder and/or the electronics unit are arranged inside the housing, wherein in particular the antenna is arranged in the peripheral region of the housing. It is also conceivable that a communication device and/or a first transceiver unit and/or an energy store and/or a data storage and/or a monitoring unit and/or in particular all electronic components of the module unit are arranged inside the housing. The described electronic components, e.g. the antenna, can be fastened in the housing by means of a potting, by bonding, by pressing, overmolding, screwing or soldering. In this way, a space-saving construction of the module unit can be realized.

The invention also relates to a module system with a mobile portable communication device and a module unit for adapting the communication device to a security system of a vehicle, in particular for the keyless activation of an access system of the vehicle, with an interface for data exchange with the communication device, and at least one communication unit for the communication with the security system, wherein the module unit is configured in such a way that the communication can be carried-out by means of a wideband communication method, in particular UWB. Therefore, the module system according to the invention provides the same advantages as have been explained in detail with reference to a module unit according to the invention. The module unit according to the invention can be provided and used in the module system according to the invention here. In addition, the module system can be suitable to perform the method according to the invention.

Furthermore, it is conceivable that the module unit and the communication device are separated from one another in terms of construction, and/or can be detached from one another in an ongoing operation. This provides the advantage that the module unit can be used with different communication devices, in particular of different manufacturers, in order to adapt these to the vehicle-onboard security system.

Advantageously, it can be provided in the scope of the invention that the module system is configured in such a way that an initiation process for authentication includes a direct first communication of the module unit with the security system, in particular for the receipt of the wake-up signal, and a direct second communication of the communication device with the security system, in particular an authentication process for the transmission of a code and/or reply signal. In this way, security can be strongly increased, since only the communication device together with the module unit can trigger an authentication process. If one of the two devices is lost, unauthorized authentication is therefore not possible. Alternatively or additionally, it can be provided that the module system is configured in such a way that the initiation process includes a direct first or further communication of the module unit with the security system for distance determination, wherein an authentication process is carried-out only with a positive result of the distance determination. The authentication process is effected in particular by a second communication unit and/or by the communication device here.

Furthermore, it can be provided in the scope of the invention that the module unit is configured in such a way that a wake-up signal received by the radio connection, in particular an information about the wake-up signal or wake-up information, can be evaluated by the communication device. The evaluation can be realized, for example, by an evaluation unit (e.g. a processor) of the communication device, wherein a storage of the communication device can be provided with a program sequence in order to perform the evaluation. The program sequence can be configured, for example, as a software or smartphone app, for example. In the case that the communication device does per se not have the communication technology for the communication with the security system (e.g. a UWB and/or LF radio connection), a wake-up signal of the security system can be received via the module unit. The module unit comprises the (first and/or second) communication unit here, which is compatible with the communication technology of the vehicle-onboard security system.

Advantageously, it can be provided in the scope of the invention that in a transition from a resting state to an operating state of the module unit, a distance determination and/or an authentication process of the module unit and/or of the mobile portable communication device with the vehicle-onboard security system (i.e. communication with the security system for authentication) is triggered. For the authentication process, in a first step, a reply signal can be sent from the communication device and/or the module unit to the security system via a communication technology such as a UWB, HF, UHF or LF radio connection, Bluetooth, GSM, LTE, UMTS, mobile radio, WLAN, NFC connection. In this case, it may be a unidirectional and/or bidirectional transmission of encoded messages. The advantage is that the communication device with the module unit thus has the functionality of an ID transponder for the vehicle-onboard security system as a result.

According to another advantage, it can be provided in the scope of the invention that upon receipt of a wake-up signal a signal is transmitted to a second transceiver unit of the communication device from a first transceiver unit and, as a result, in particular an authentication process with the security system can be triggered by the communication device. Typically, a mobile portable communication device such as a smartphone or a laptop does not support the LF radio connection for the reception of the wake-up signal or the communication technology for emission of the reply signal to the security system.

In order to nevertheless be able to use the communication device as ID transponder for the security system, it is necessary that the module unit supports the communication technology of the communication device. By the corresponding transceiver unit of the module unit for the data exchange with the communication device, the communication device can communicate at least with the security system and, as the case may be, with further vehicle-sided systems.

According to an advantageous development of the invention, communication of the communication device with the vehicle-sided security system, in particular for performing an authentication process, and possibly with further vehicle-onboard systems such as GSM, LTE, UMTS, mobile radio, NFC, HF, UHF, LF, UWB, WLAN, and/or Bluetooth signals, can take place, and, in particular for communication, a third transceiver unit of the communication device can be provided, wherein the third transceiver unit may comprise a GSM, LTE, UMTS, mobile radio, NFC, HF, UHF, LF, UWB, WLAN and/or Bluetooth antenna. In particular, it can be provided that the communication device is characterized in that it comprises e.g. a (third) transceiver unit and/or an antenna, which is suitable to communicate via a mobile radio technology such as GSM, LTE, UMTS and/or a further communication technology, such as NFC, HF, UHF, UWB, LF, WLAN and/or Bluetooth. Likewise, a combination can be possible, as the communication device comprises a multiband or multifrequency transceiver unit, for example. It can be possible here that each communication technology of the communication device is different from the communication technology of the security system, in particular for the transmission of the wake-up signal. If, however, the authentication process can occur at least partially via one of the communication technologies of the communication device, this provides the advantage that no further components are required for the transmission of the reply signal to the security system. In this case, the reply signal can be sent through a mobile radio connection, for example, since the security system, in particular a vehicle-onboard communication module, supports this transmission standard. In order that a used can control and/or monitor the authentication process, it can be provided that the communication device comprises a storage with a program sequence, such as a software or a smartphone app. The program sequence, e.g. including a method according to the invention, can be suitable for evaluate the received wake-up signal and/or received information of the module unit and send it to a display element of the communication device and display it to the user. To that end, it can be provided here that the communication device comprises a display and/or a touchscreen as a display element. The authentication process can be started via a control of the smartphone, e.g. via the touchscreen or a keyboard, and e.g. information about the vehicle or the security system can be retrieved or displayed. It is also conceivable that the control is suitable for the management and/or generation of codes for authentication, e.g. by the generation of random values by the user input. Thus, a large variety of new control and monitoring options can be provided to the user.

It is furthermore conceivable that a change unit is provided, wherein, in a transition from a resting state to the operating state, an authentication process of the mobile, portable communication device and/or of the module unit with the security system and/or the vehicle can be triggered by the change unit, wherein preferably the authentication process takes place at least partially via the wideband communication method, preferably via an ultra-wideband communication. Alternatively or additionally, it can be provided that an evaluation unit of the communication device is provided, so that a signal received through a radio connection and/or through the communication by means of the wideband communication method, preferably a wake-up signal, particularly preferably an information about the wake-up signal, can be evaluated by the evaluation unit. The information about the wake-up signal includes e.g. an information that a wake-up signal has been received, and/or further information such as information for a pre-authentication. The evaluation unit can, for example, be used for the pre-authentication and/or the actual authentication process and/or for the distance determination. Thus, it can be provided that the evaluation unit carries out an authentication process only when a positive result has been determined in the distance determination. In this way, security in the authentication can be further improved.

Furthermore, it can be possible that the communication device is a smartphone, a laptop, a radio telephone, an ID transponder, e.g. for a third-party access system, an electronic key, a personal computer, a tablet PC, a media device such as a music player, a mobile phone, a personal computer and/or a smartphone-like communication device, a watch, a wristband and/or glasses with electronic components and/or another electronic device. The communication device can be characterized here in that it offers, to the user, communication technologies such as mobile radio or an internet connection or IP telephony, and that these are at least partially present, and that it comprises at least one (e.g. third) transceiver unit suitable to that end. Through the use of the module unit, a wake-up signal can be received, transmitted to the communication device, and the reply signal can be transmitted to the security system via the communication technology of the communication device. Just as well, a hybrid solution is conceivable, in which the communication technology of the transceiver unit of the communication device is different from the communication technology of the security system (i.e. at least of a vehicle-onboard communication module). Here, e.g. the supply signal can be sent from the security system via mobile radio (e.g. GSM) connection. Just as well, data can be exchanged bidirectionally via the transceiver unit, in order to be able to receive and display information about the state of the security system or of the vehicle on the communication device. This provides the advantage that the communication device offers the user a wide range of further, new applications to the user in addition to its conventional functionality.

It can also be advantageous that a communication between the security system of the vehicle and the communication device can be performed by the module unit via the wideband communication method in the scope of the invention. Alternatively or additionally, it is conceivable that a communication of the module unit with the security system is possible and/or that data can be sent from the communication device to the security system through the module unit. It can also be possible that a communication of the communication device with the security system is possible by the module unit, in particular for the transmission of a code, wherein, in particular, communication takes place in a frequency range which is different from the frequency range of the radio connection for the transmission of the wake-up signal. As a result, a frequency range for the transmission of the wake-up signal can be selected independently from the radio connection for the transmission of the reply signal, in order to increase the security of the transmission, for example.

The subject-matter of the invention also is a security system, in particular for the keyless activation of an access system for vehicles. It is provided here that the security system comprises a mobile, portable communication device and a module unit, in particular according to the invention, for adapting the communication device to the security system. A module system according to the invention can also be provided. The module unit preferably comprises an interface for the data exchange with the communication device as well as a communication unit for the communication and/or radio connection with the security system. The module unit is particularly configured in such a way that a communication according to a wideband communication method between the communication unit and the security system or the vehicle can be realized. As a result, the security system according to the invention provides the same advantages as have been explained in detail with reference to the module unit according to the invention and a module system according to the invention.

Advantageously, it can be provided in the invention that at least one first communication module is provided in the interior of the vehicle and at least one second communication module is provided on the external side of the vehicle, so that the position of the module unit and/or of the communication device can be detected inside and/or outside the vehicle. This function is particularly interesting when the module system according to the invention also practically serves as an “ignition key” and/or key for the immobilizer system for the vehicle and cooperates with corresponding systems in the vehicle. It can also be conceivable that merely the communication module is provided, wherein at least one antenna (in particular UWB and/or LF antenna) is arranged in the vehicle interior and a further antenna is arranged outside the vehicle. Thus, a reliable localization of the communication can be effected. The (first and/or second) communication module can preferably by suitable for communication by UWB here.

According to a further advantage of the invention, it can be provided that the security system comprises a (e.g. UWB and/or LF and/or HF) communication module, in particular for the emission of a wake-up signal, wherein in particular the communication module is formed in such a way that security queries for position detection (of the communication device and/or the module unit) and/or a distance determination for determining a distance information about a distance between the vehicle and the module unit is possible. It can also be provided that a first and/or second communication module at the side of the vehicle for the emission of the wake-up signal via the radio connection and a third communication module for receiving the reply signal of the communication device are present, wherein the frequency range of the first and/or second communication module is different from the frequency range of the third communication module (and does not overlap therewith). The position detection can, for example, be effected in that the radio connection, e.g. a UWB and/or LF radio connection, only has a certain range. Due to the fact that the signal is strongly shielded by the vehicle body, a detection whether the communication device is situated inside or outside the vehicle is possible. As a result, it is enabled that e.g. a starting of the engine is not possible when the communication device is situated outside the vehicle.

It can also be provided that the communication module comprises at least one UWB, LF, HF, UHF, GSM, LTE, NFC Bluetooth antenna or at least one UWB, LF, HF, UHF, GSM, LTE, NFC Bluetooth transmitter and receiver module. A localization of the communication device is also conceivable to take place via these communication technologies.

In addition, according to the invention, the communication range between the communication module and the module unit, in particular of the first or second communication unit, and/or the communication device can be limited to at most 5 cm, 10 cm, 15 cm, 50 cm, 1 m, 1.5 m, 2 m or 5 m. Thus, an unauthorized activation of the closing device and an interception of the data exchange can be prevented.

The invention also relates to a method for adapting a mobile, portable communication device to a security system, in particular for the keyless activation of an access system of the vehicle, with a module unit, wherein the module unit comprises an interface for the data exchange with the communication device, and the module unit further comprises at least one communication unit for the communication with the security system, wherein the communication of the communication unit with the security system (i.e. in particular with the vehicle) is performed by means of a wideband communication method, preferably via a radio connection. Via the radio connection, for example a distance information and/or an authentication information and/or a wake-up signal for initiating the authentication process can be transmitted. The module unit is configured in such a way that a communication between the communication unit and the security system can be realized. As a result, the method according to the invention provides the same advantages as have been described in detail with respect to the module unit according to the invention, a module system according to the invention as well as a security system according to the invention. Moreover, the module unit according to the invention and/or the communication device can comprise electronic components for performing the method according to the invention and/or a storage, which contains a program sequence for performing the method according to the invention, in particular for evaluating the wake-up signal.

Furthermore, it can be provided in the method according to the invention that a communication module of the security system emits a wake-up signal, the wake-up signal is received by the (first and/or second) communication unit, and upon reception of the wake-up signal by the (first and/or second) communication unit, the communication device and/or the module unit triggers a distance determination and/or an initiation process and/or an authentication process. It is conceivable for the triggering of the initiation process that the wake-up signal is converted and/or processed by the module unit, the change unit and/or an electronics unit in such a way that an information of the wake-up signal can be evaluated by the communication device through the data connection. Now, the security system is capable of recognizing an approach of the module system by the emission of the wake-up signal, for example, if, upon reception of the wake-up signal, the module unit and/or the communication unit sends back a corresponding (reply) signal to the security system, for example. A corresponding transceiver unit of the module unit can be provided to that end. It can also be possible that the approach of the module system is detected by an evaluation of the electromagnetic field or of the electromagnetic coupling, by proximity sensors or by sensors which detect a user action (such as the touching of a door handle). This provides the advantage that the module system can reliably be used as the ID transponder for the security system.

It is conceivable that the wideband communication method is an ultra-wideband communication method for near field radio communication, wherein preferably the bandwidth of the frequency ranges used for the communication is at least 500 MHz and/or at least 1000 MHz. In particular, the communication range is limited in the wideband communication method to a predetermined (maximum) distance, so that preferably a distance determination can be effected through this limitation. Due to this physical limitation, an authentication process is preferably only possible if the distance between the module unit and the vehicle is below the maximum distance. Further options for distance determination are, for example, a time-of-flight analysis of at least one radio signal of the wide-band communication method and/or an evaluation of the signal strength. As a result, the advantage can be achieved that security during the authentication at the security system is increased further. In particular, it is conceivable that the localization of the module unit due to the distance determination is effected with a precision of at least 5 cm and/or at least 8 cm and/or at least 10 cm.

It can be optionally provided that a wake-up signal is received by a first or second communication unit and, in particular upon receipt of the wake-up signal, the communication device and/or the module unit triggers an authentication process. It can be provided here that the authentication process is initiated only in the event that a distance between the module unit and the vehicle is below a maximum distance. To that end, for example, a distance determination is performed after the reception of the wake-up signal and/or prior to the initiation of the authentication process. Thus, security of the authentication is increased further.

Furthermore, it is conceivable that the communication between the module unit and the vehicle, in particular between the communication unit and the security system of the vehicle, is at least partially performed in an encrypted manner, wherein preferably an authentication information in the authentication process and/or a distance information is transmitted to the vehicle in an encrypted manner. To that end, for example an encryption device and/or a correlation receiver of the module unit is provided, wherein the encryption can, as an alternative or in addition, also be effected by the communication device. Thus, a manipulation of security-relevant data is reliably prevented.

According to another advantage, it can be provided that upon reception of an ultra-wideband and/or HF and/or LF signal, preferably a wake-up signal, a distance determination is initiated, whereby preferably a distance information about a distance between the module unit and the vehicle is determined, wherein preferably the distance determination is at least partially performed by an electronics unit of the module unit and/or by an evaluation unit of the communication device. For example the communication, i.e. in particular the radio signal, can be evaluated for the distance determination, and/or another localization technology can be used. The further positioning technology is, for example, a GPS technology of the communication device. As a result, a reliable positioning and/or localization of the module unit can be ensured.

Furthermore, it is conceivable that an authentication process is initiated dependent upon a determined distance between the module unit and the vehicle preferably only in the case that the determined distance is smaller than a maximum distance between the module unit and the vehicle, wherein preferably the authentication process includes a data exchange via LF and/or HF and/or UWB communication. Alternatively or additionally, it can be provided that a time-of-flight analysis is performed by the module unit, in particular at least partially by the communication unit, preferably by a first communication unit, via ultra-wideband, for the determination of a distance information about the distance and/or for the distance determination. To that end, for example, a UWB radio signal received by the communication unit is evaluated. This enables a reliable and secure localization.

Furthermore, it can be provided in that scope of the invention that the distance information is transmitted from the communication unit of the module unit to a communication module of the security system in an encrypted and/or interception-proof and/or forgery-proof manner. To that end, the communication unit includes, for example, an encryption device and/or a correlation receiver. The transmission allows evaluating the distance by the vehicle here, wherein subsequently, an authentication process can be initiated by the vehicle and/or by the security system, for example. Thus, since the distance information is a security-relevant information, a manipulation of the authentication process can be prevented due to the encryption.

Furthermore, if the position of the module system is detected to be inside the vehicle and/or upon a positive identification verification by the authentication process, the immobilizer system can be unblocked, for example, and/or the engine ignition can be permitted when pushing the start button, or user-specific pre-settings such as the seat position or lighting system can be loaded and implemented. A vehicle-onboard control electronics can be provided to that end. If the module system is detected to be outside the vehicle, these functions are completely or partially disabled, but opening the doors is possible, for example.

Finally, the invention also relates to a vehicle, in particular to a motor vehicle having the module system according to the invention as well as, as the case may be, the method according to the invention.

Further advantages, features and details of the invention result from the following description, in which exemplary embodiments of the invention are described individually with reference to the drawings. In this case, the features mentioned in the claims and in the description can each individually itself or in any combination be essential to the invention. The Figures show in:

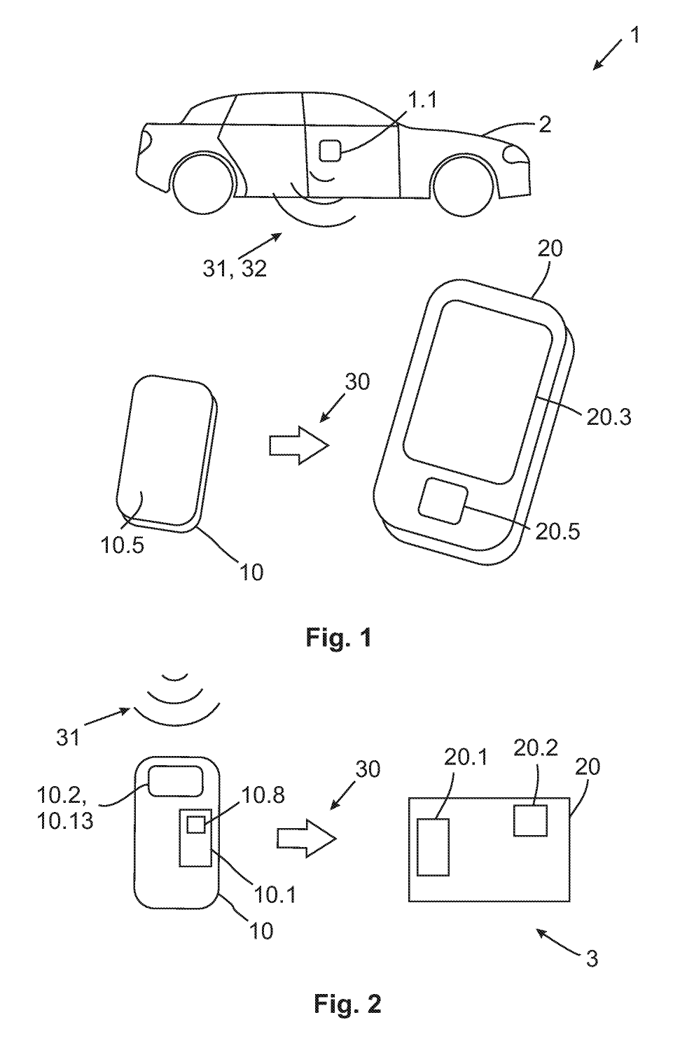

FIG. 1 a schematic representation of a security system according to the invention with a module unit according to the invention as well as a communication device and a motor vehicle,

FIG. 2 another schematic view of the module unit according to the invention as well as of the communication device,

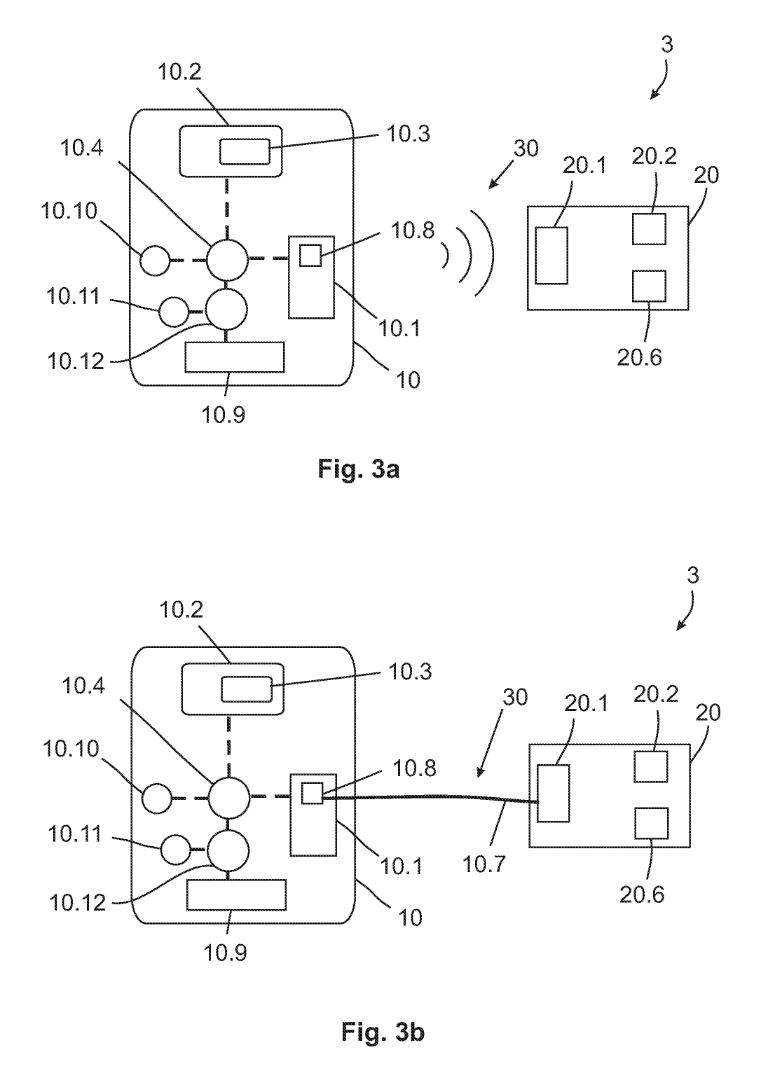

FIG. 3a a schematic representation of a module unit according to the invention for the visualization of the communication with a communication device via a radio connection,

FIG. 3b a further schematic representation of the module unit according to the invention for the visualization of the communication via a cable connection to the communication device,

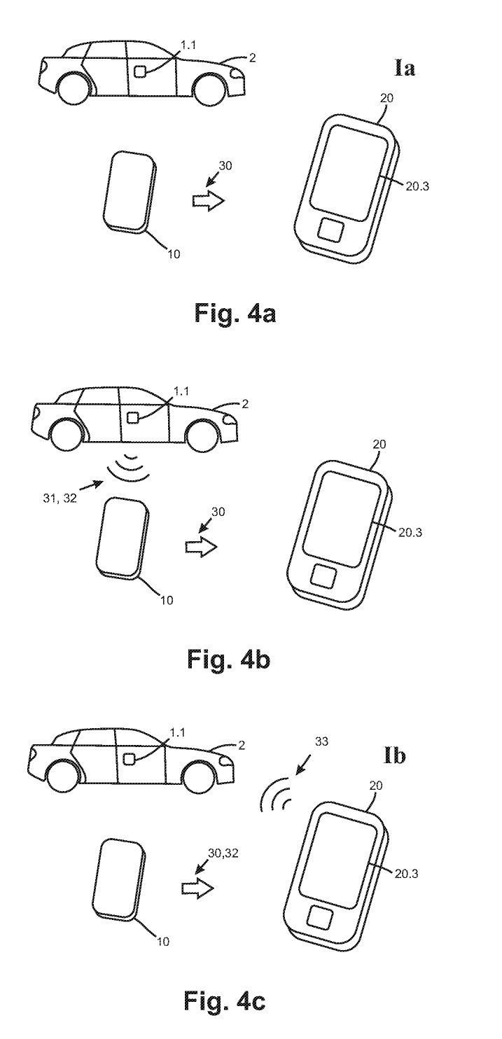

FIG. 4a a schematic representation for the visualization of a module unit according to the invention in the resting state,

FIG. 4b a further representation of the module unit according to the invention for the visualization of the receipt of a wake-up signal,

FIG. 4c a further schematic representation for the visualization of the module unit according to the invention in the operating state,

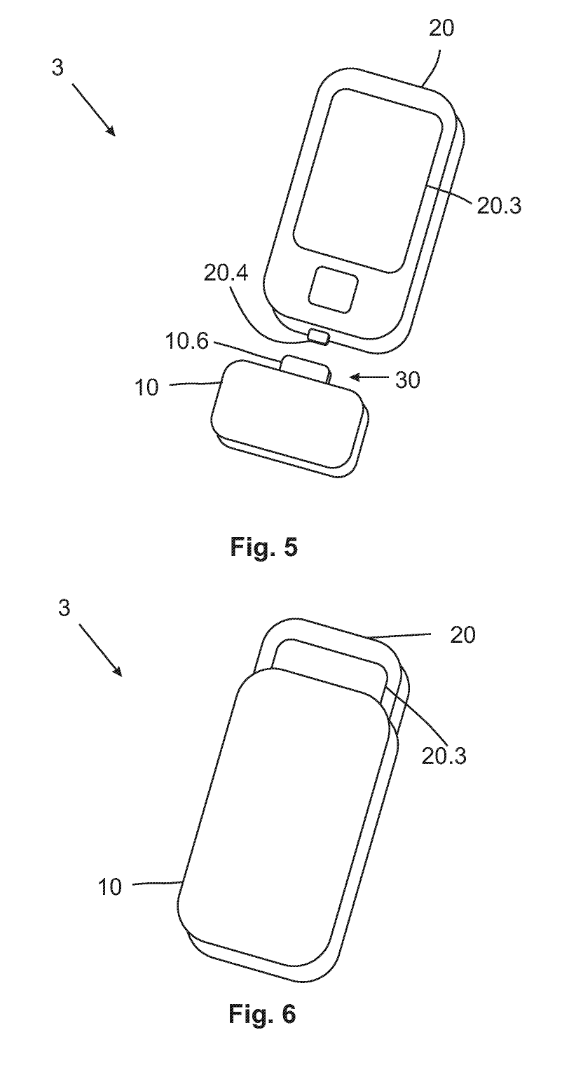

FIG. 5 a schematic representation of a first embodiment variant of a module system according to the invention,

FIG. 6 a schematic representation of a second embodiment variant of a module system according to the invention,

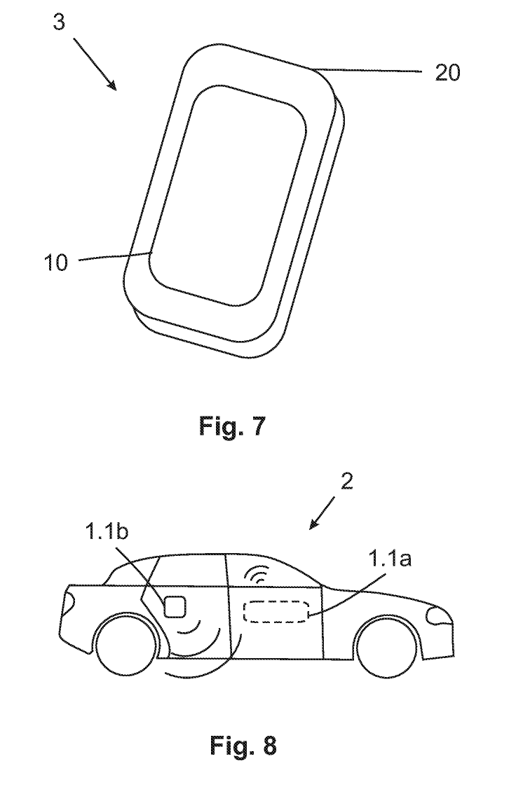

FIG. 7 a schematic view of a third embodiment variant of a module system according to the invention,

FIG. 8 a schematic representation of a motor vehicle, of a first and a second vehicle-sided communication module,

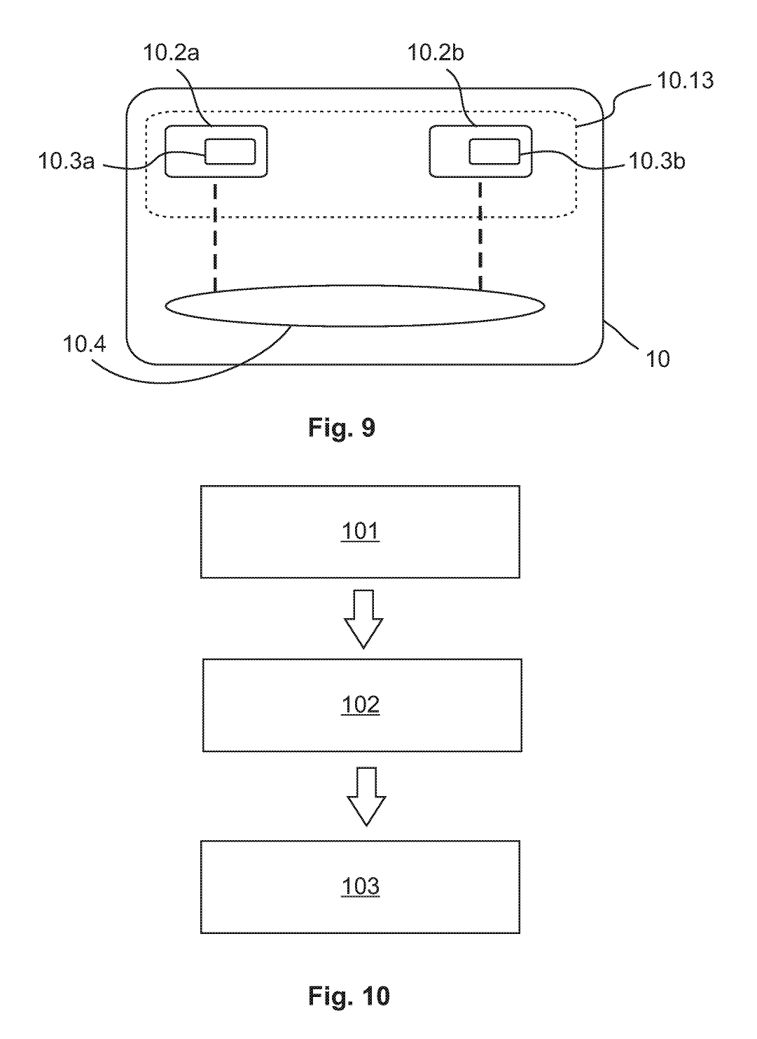

FIG. 9 a schematic representation of parts of a module unit according to the invention, and

FIG. 10 a schematic representation for the visualization of method steps of a method according to the invention.

Identical reference characters are used for the same technical features even of different exemplary embodiments throughout the Figures.

FIG. 1 schematically shows a security system 1 according to the invention, as well as a module unit 10 according to the invention. The security system 1 comprises a communication module 1.1 at a vehicle 2. The communication module 1.1 can send signals via a radio connection 31, e.g. a wake-up signal 32. The signals, which are sent via the radio connection 31, can be received by corresponding ID transponders of the security system 1. To that end, such an ID transponder usually supports the communication technology of the security system 1, which is used for sending signals via the radio connection 31. For example, the communication technology used for the wake-up signal 32 is a UWB and/or LF radio connection. However, this comes with the disadvantage that a user must always carry a separate ID transponder, which also supports the communication technology. This is also necessary when a user already carries other communication devices 20 with them, such as a smartphone, a tablet or a laptop. These devices do usually not support the communication technology for the reception of the vehicle-sided wake-up signal 32, since they e.g. do not comprise any UWB or LF antenna and no corresponding interface or communication electronics. However, a use of these communication devices 20 as ID transponders would provide additional comfort to the user, since a separate ID transponder can be dispensed with, and the extended functionality of the communication device 20 can be used, for example in order to have vehicle data displayed on a display of the communication device 20. In order to adapt such communication devices 20 to the security system 1, the module unit 10 shown in the Figures is used in accordance with the invention. The module unit 10 is suitable to receive the signals of the vehicle-side communication module 1.1 via the radio connection 31 and, as the case may be, to provide the signals and/or the information thereof to the communication device 20 via a data exchange 30.

The radio connection 31 can refer to a LF radio connection and/or a UWB radio connection. The signals may contain information about the wake-up signal 32 and/or distance information about a distance between the vehicle 2 and the module unit 10 and/or state information about the state of the security system 1, for example, which can be displayed to the user on a display 20.3 of the communication device 20. It is also conceivable that the display 20.3 is configured as a touchscreen, and allows control of the security system 1. Alternatively, control can be possible via a keyboard 20.5 of the communication device 20, for example. It can be seen that the module unit 10 has a compact shape with the housing 10.5, and is formed to be considerably smaller than the communication device 20. Thus, it can be transported, in a bag, by the user, for example connected at the communication device 20 and/or separately from the communication device. Likewise, an arrangement e.g. (fixedly) at the vehicle 2 or separately from the communication device 20 is conceivable, wherein the data exchange 30 is then or can then be configured as a wireless connection.

FIG. 2 schematically shows further components of the module unit 10 according to the invention as well as of the communication device 20 in a partial sectional view. The signals or data sent via the vehicle-side radio connection 31, in particular a UWB connection 31, can be received by a communication device 10.13 with at least one communication unit 10.2 of the module unit 10. In addition, the module unit 10 is in data connection with the communication device 20 via an interface 10.1. To that end, a first transceiver unit 10.8 can be provided, which permits a data exchange 30 with a second transceiver unit 20.1 of the communication device 20. If now a wake-up signal 32 is received, for example, a distance determination and/or an authentication process, e.g. of the communication device 20, can be triggered. In order to send signals for authentication to the security system 1, the communication device 20 may comprise a third transceiver unit 20.2, for example. This third transceiver unit 20.2 may comprise e.g. a HF antenna for HF radio connection with the security system 1, or be suitable for a connection via a communication technology such as GSM, LTE, WLAN, UMTS, UWB, Bluetooth, NFC, or another mobile radio connection.

FIGS. 3a and 3b schematically show the structure of a module unit 10 according to the invention in a schematic sectional view. The dashed line indicates the functional and/or electronic connection of the components amongst one another. The electronic connection can be effected directly or indirectly via conductor tracks, for example. It is also conceivable that individual, discrete components are not necessary, but instead the same function is made possible by, for example, microprocessors or the electronic components. In this case, the module unit 10 comprises a communication device 10.13 with a communication unit 10.2, e.g. a first communication unit 10.2a, in particular a UWB communication unit, and/or a second communication unit 10.2b which may each include one antenna 10.3, e.g. a UWB and/or LF antenna. The communication device 10.13 can receive signals, which are sent via the radio connection 31. These signals can subsequently be forwarded to an electronics unit 10.4 and/or a change unit 10.12. The electronics unit 10.4 and/or the change unit 10.12 is capable of evaluating these signals and/or the information of these signals and of transmitting them in the same or altered form to further components of the module unit 10. To that end, the electronics unit 10.4 and/or the change unit 10.12 is electrically or functionally connected to the interface 10.1. The interface 10.1 comprises e.g. a first transceiver unit 10.8, in order to communicate with the communication device 20. Furthermore, it is conceivable that a data storage 10.10, a monitoring unit 10.11 as well as an energy store 10.9 are provided, which are electronically or functionally connected to the electronics unit 10.4 and/or change unit 10.12. The data storage 10.10 can, for example, contain a program sequence, which is provided to the communication device 20, e.g. via the data exchange 30. The program sequence may subsequently be stored in a storage (not shown) of an evaluation unit 20.6 and be executed by the evaluation unit 20.6. The program sequence can remain stored permanently in the storage of the evaluation unit 20.6 or of the communication device 20 after having been transmitted from the communication device 20 here. In this case, a non-volatile memory is concerned, for example, such as a SD card. The energy store 10.9 can serve for the energy supply of the module unit 10, or also for the energy supply of the communication device 20. The exchange of energy between the communication device 20 and the module unit 10 can, for example, take place through the connection between the first transceiver unit 10.8 and the second transceiver unit 20.1 of the communication device 20. Likewise, it is possible that the energy store 10.9 is charged with energy of the communication device 20 through the said connection. To that end, the monitoring unit 10.11 can monitor the charging state of the energy store 10.9 or also the energy supply of the module unit 20 and, as the case may be, connect the energy store 10.9, which can be a back-up energy store.

Via the radio connection 31, a wake-up signal 32 of the security system 1 can be received by the communication device 10.13, e.g. the first communication unit 10.2a and/or the second communication unit 10.2b. This wake-up signal 32 serves for triggering (initiating) an authentication process and/or activation of the first communication unit 10.2a and/or a distance determination. It can also be reasonable that the module unit 10 assumes different states I, since an authentication process must be initiated only upon receipt of the wake-up signal 32. Thus, it can be provided that the interface is in the energy-saving mode in a resting state la of the module unit 10 and, upon reception of a wake-up signal 32, the module unit 10 changes to an operating state lb. In the operating state lb, a data exchange 30 with the communication device 20 can be triggered by the electronics unit 10.4 and/or the change unit 10.12, wherein an increased energy demand of the interface 10.1 becomes necessary.

FIG. 3a shows that the data exchange 30 can take place via a radio connection, for example, wherein in this case, the first transceiver unit 10.8 as well as the second transceiver unit 20.1 comprises antennas, for example, and support a communication technology such as UWB or Bluetooth, for example. Likewise, it can be provided in accordance with FIG. 3b that the data exchange 30 between the first transceiver unit 10.8 and the second transceiver unit 20.1 is effected in a wired manner. Thus, FIG. 3b schematically shows a cable 10.7.

FIGS. 4a, 4b and 4c schematically show the communication between the vehicle-onboard communication module 1.1, the module unit 10 and the communication device 20. The module unit 10 and/or the communication device 20 is in a resting state in FIG. 4a here. The communication module 1.1, in particular a HF and/or LF and/or UWB communication module 1.1. is located at the external side of the vehicle 2, for example, in particular on an outer door handle, but does not emit a signal. Likewise, it is possible that the illustrated communication module 1.1 actually emits a radio signal, but that either this signal does not comprise a wake-up signal 32 or the module unit 10 is situated outside the range of the radio connection 31.

Once the radio signal or the wake-up signal 32 can be received via the radio connection 31 by the module unit 10, as shown in FIG. 4b, corresponding information can be sent to the communication device 20 via the data exchange 30. The sending of the radio signals or the wake-up signal 32 via the radio connection 31 can be detected, for example, by a determined approach of a user to the vehicle 2 using a proximity sensor, which in particular is arranged in the external door handle.

Then, as illustrated in FIG. 4c, the authentication process and/or the distance determination is initiated. The wake-up signal 32 (or the corresponding information), which, as illustrated in FIG. 4b, has been received via the radio connection 31 by the module unit 10, can now be forwarded via the data exchange 30 to the communication device 20. Preferably, after an evaluation of the wake-up signal 32, the communication device 20 starts sending a reply signal to the security system 1 of the vehicle 2 via the communication connection 33. The communication connection 33 is, for example, a radio connection in particular via mobile radio, Bluetooth or NFC or UWB. The reply signal can contain a code, for example, which is evaluated for identification verification by the security system 1, e.g. a vehicle-sided electronics. Upon receipt of the correct authentication code and in particular a prior distance determination, in which the distance determined hereby must not exceed a maximum distance between module uni 10 and vehicle 2, the security system 1 can open, for example, a closing device, in particular a central locking system, in order that access to the vehicle 2 is possible.

FIG. 5 shows a module system 3 according to the invention, which includes the module unit 10 as well as the communication device 20. In order that a user can use the communication device 20 as an ID transponder for the security system 1, i.e. for an adaption of the communication device 20 to the security system 1, a data connection of the communication device 20 with the module unit 10 is required. In order to nevertheless enable a comfortable and practical transport of the communication device, FIG. 5 shows a first embodiment variant. In this case, the module unit 10 can be configured in such a way that it adapts in shape and size to the communication device 20. In addition, it can be connected, via a plug connection 10.6, to a plug connector 20.4 of the communication device 20 in a reversibly releasable manner. This connection for data exchange 30 can be, for example, a USB connection or a connection technology predetermined by the communication device 20.

FIG. 6 schematically shows a second embodiment variant, in order to connect a module unit 10 according to the invention with the communication device 20 (possibly wireless). In this case, the module unit 10 is configured as a phone covering or receptacle for the communication device 20, in particular as a backpack. Since many users use a corresponding cover or storage for communication devices 20, such as mobile phones or smartphones, the corresponding configuration of the module unit 10 is particularly practical and multifunctional for the user. In the case that the communication device 20 is situated in the module unit 10, operation of the display 20.3 can nevertheless be possible by a recess (not illustrated) of the module unit 10. Through the use of transparent materials for the module unit 10, the observing or operating the display 20.3 is still possible. However, such measures for the operation of the communication device 20 are not necessarily required. Since active operation of the ID transponder by the user is not necessary in Passive Keyless-Entry systems, the authentication process is automatically initiated by the module unit 10 or by the communication device 20 upon reception of the wake-up signal 32. Thus, the user may leave the communication device 20 within the module unit 10, and nevertheless cause e.g. an opening of the doors of the vehicle 2 when approaching the security system 1.

The module unit 10 can be connected to the communication device 20 for data exchange 30 via a radio connection, for example, such as Bluetooth or NFC to ensure a smooth handling.

A third embodiment variant of the module unit 10 according to the invention is shown in FIG. 7. A rear view of the module system 3 or the communication device 20 according to the invention is shown schematically here. In this case, the module unit 10 is e.g. configured as an accumulator or energy store for the communication device 20. Thus, it can be provided that the energy store 10.9 of the module unit 10 accordingly causes an energy supply of the communication device 20. The configuration of the module unit 10 as an energy store for the communication device 20 provides the advantage that an arrangement of the module unit 10 can be effected in a very space-saving manner, without affecting the appearance of the communication device 20. It is also conceivable that the module unit 10 is configured as a battery lid, SD card or the like for the communication device 20. In the embodiment variant of the module unit 10 according to the invention, in FIG. 7, this module unit is configured as a backpack for the communication device 20. Thus, the module unit 10 is integrated in or on the communication device 20. In this case, the above-mentioned coupling means can, in particular, serve for the mechanical fastening of the module unit to the communication device.

FIG. 8 schematically shows a motor vehicle 2, which comprises at least two communication modules 1.1. Here, a first communication module 1.1a is arranged in the interior of the vehicle, and a second communications module 1.1b is arranged on the exterior of the vehicle. This can effect that a first communication module 1.1a only emits radio signals to the outside of the vehicle 2 and at least a second communication module 1.1b emits radio signals to the inside of the vehicle 2. Since the radio signals are strongly weakened in the interior of the vehicle by the vehicle body, a locating of the ID transponder or of the module unit 10 and of the communication device 20 is possible, for example. This function is of particular interest if the module system 3 according to the invention practically also serves as an “ignition key” and/or as a key for the immobilizer for the vehicle 2. Here, both the first communication module 1.1a and the second communication module 1.1b can preferably support an UWB communication technology.

FIG. 9 shows a communication device 10.13 of a module unit 10 according to the invention, wherein two different communication units 10.2 are illustrated. A first communication unit 10.2a comprises an UWB-interface for Ultra-wideband communication, wherein a second communication unit 10.2b includes a HF or LF interface for HF or LF communication. Furthermore, a first (UWB) antenna 10.3a of the first communication unit 10.2a and a second (HF or LF) antenna 10.3b of the second communication unit 10.2b is provided, which are at least partially arranged within the module unit 10. Furthermore, other communication units 10.2 (not illustrated) can be provided as well. All communication units 10.2 can be electrically connected to an electronics unit 10.4 for the evaluation of the signals received through the communication.

FIG. 10 schematically illustrates the method steps of a method according to the invention. In a first method step 101, the wake-up signal 32 is emitted by the security system 1. This is followed by a second method step 102, wherein the wake-up signal 32 is received by the communication unit 10.2. Thereupon, after having received the wake-up signal 32, an authentication process and/or a distance determination is triggered in the third method step 103.

The above description of the embodiments describes the present invention exclusively by means of examples. However, individual features of the embodiments, as long as technically reasonable, can be freely combined with one another without departing from the scope of the present invention.

### LIST OF REFERENCE CHARACTERS

1 security system
1.1 communication module
1.1a first communication module
1.1b second communication module
2 vehicle
3 module system
10 module unit
10.1 interface
10.2 communication unit
10.2a first communication unit, UWB communication unit
10.2b second communication unit, LF communication unit
10.3 antenna
10.3a first antenna
10.3b second antenna
10.4 electronics unit
10.5 housing
10.6 plug connection
10.7 cable
10.8 first transceiver unit
10.9 energy store
10.10 data storage
10.11 monitoring unit
10.12 change unit
10.13 communication device
20 communication device
20.1 second transceiver unit
20.2 third transceiver unit
20.3 display
20.4 plug connection
20.5 keyboard
20.6 evaluation unit
30 data exchange
31 radio connection
32 wake-up signal
33 communication connection
101 method step: Emitting, by the security system, the wake-up signal
102 method step: Receiving, by the communication unit, the wake-up signal
103 method step: Triggering of an authentication process
I state of the module unit
la resting state of the module unit
lb operating state of the module unit

1. A module unit for adapting a mobile, portable communication device to a security system of a vehicle, having
an interface for data exchange with the communication device, and at least one communication unit for the communication with the security system, wherein
the module unit is configured in such a way that the communication can be performed by a wideband communication method.

2. The module unit according to claim 1,
wherein
the communication unit for communication by the wideband communication method is configured as an ultra-wideband communication unit, wherein preferably the ultra-wideband communication unit is configured as a first communication unit, and at least one second communication unit is provided, which particularly preferably is configured at least as a LF and/or HF communication unit.

3. The module unit according to claim 1,
wherein
a wake-up signal of the vehicle, preferably at least an ultra-wideband or LF or HF wake-up signal from the module unit, preferably at least the first or second communication unit, is receivable by an antenna, preferably at least by an ultra-wideband or LF or HF antenna.

4. The module unit according to claim 1,
wherein
the module unit comprises an electronics unit for the evaluation of received radio signals, which is connected to at least a change unit or the interface or the communication unit in such a way that a transition from a resting state to an operating state can be performed by the change unit.

5. The module unit according to claim 1,
wherein
the module unit is configured in such a way that during or after a transition of the module unit from a resting state to an operating state, the communication unit, preferably the first communication unit, for ultra-wideband communication, can be activated, wherein preferably a second communication unit can be activated for at least LF or HF communication both in the resting state and in the operating state.

6. The module unit according to claim 1,
wherein
the module unit is configured in such a way that upon receipt of a signal by a first or second communication unit, preferably of a wake-up signal, a data exchange of at least the interface with the communication device be initiated or a first communication unit can be activated.

7. The module unit according to claim 1,
wherein
the interface comprises a first transceiver unit, wherein the first transceiver unit preferably is at least a Bluetooth, NFC, Infrared, GSM, LTE, UMTS, mobile radio, HF, UHF, LF, WLAN or USB interface.

8. The module unit according to claim 1,
wherein
the module unit is formed as a backpack for the communication device, preferably at least as a battery case lid or memory card or SD card or mobile cover or attachment or plug or accumulator and.

9. A module system with a mobile, portable communication device and a module unit for adapting the communication device to a security system of a vehicle, having
an interface for the data exchange with the communication device, and at least one communication unit for the communication with the security system, wherein
the module unit is configured in such a way that the communication can be performed by means of a wideband communication method.

10. The module system according to claim 9,
wherein
an evaluation unit of the communication device is provided, so that a signal, preferably a wake-up signal, received at least through a radio connection or through the communication by means of the wideband communication method, can be evaluated by the evaluation unit.

11. The module system according to claim 9,
wherein
a change unit is provided, wherein in a transition from a resting state to an operating state by the change unit, an authentication process of the mobile portable communication device with the security system can be triggered, wherein preferably the authentication process takes places at least partially via the wideband communication method, preferably via an ultra-wideband communication.

12. The module system according to claim 9,
wherein
the communication of the communication device with the security system is effected at least with ultra-wideband, GSM, LTE, UMTS, mobile radio, NFC, HF, UHF, LF, WLAN or Bluetooth signals, and a third transceiver unit of the communication device is provided, wherein the third transceiver unit.

13. The module system according to claim 9,
wherein
the communication device is at least a smartphone, laptop or a mobile phone.

14. The module system according to claim 9,
wherein
a communication between the security system of the vehicle and the communication device via the wideband communication method can be performed by means of the module unit.

15. The module system according to claim 9,
wherein
the module unit is formed for adapting a mobile, portable communication device to a security system of a vehicle having an interface for data exchange with the communication device, and at least one communication unit for the communication with the security system, wherein the module unit is configured in such a way that the communication can be performed by a wideband communication method.

16. A method for adapting a mobile, portable communication device to a security system of a vehicle, with a module unit which
comprises an interface for the data exchange with the communication device,
and comprises at least one communication unit for the communication with the security system, wherein
the communication of the communication unit with the security system is performed by a wideband communication method.

17. The method according to claim 16,
wherein
the wideband communication method is an ultra-wideband communication method for nearfield communication, wherein preferably the bandwidth of the frequency ranges used for communication at least 500 MHz or at least 1000 MHz.

18. The method according to one claim 16,
wherein
a wake-up signal is received by a first or second communication unit, and at least the communication device or the module unit triggers an authentication process upon receipt of the wake-up signal.

19. The method according to claim 16,
wherein
the communication is performed at least partially in an encrypted manner, wherein an authentication information in at least an authentication process or a distance information to the vehicle is transmitted in an encrypted manner.

20. The method according to claim 16,
wherein
a distance determination is initiated upon reception of at least an ultra-wideband or HF or LF signal, whereby preferably a distance information about a distance between the module unit and the vehicle is determined, wherein preferably the distance determination is performed at least partially by means of an electronics unit at least of the module unit or by an evaluation unit of the communication device.

21. The method according to claim 16,
wherein
depending on a determined distance between the module unit and the vehicle, an authentication process is initiated, wherein preferably the authentication process includes a data exchange at least via LF or HF or UWB communication.

22. The method according to claim 16,
wherein
a time-of-flight analysis is performed by the module unit, preferably by a first communication unit, at least for the distance determination or for the determination of a distance information.

23. The method according to claim 16,
wherein
a distance information is transmitted from the communication unit of the module unit to a communication module of the security system in at least an encrypted or interception-proof or forgery-proof manner.

24. The method according to claim 16, at least having a module unit for adapting a mobile, portable communication device to a security system of a vehicle, having an interface for data exchange with the communication device and at least one communication unit for the communication with the security system, wherein the module unit is configured in such a way that the communication can be performed by a wideband communication method or a module system with a mobile, portable communication device and a module unit for adapting the communication device to a security system of a vehicle, having an interface for the data exchange with the communication device, and at least one communication unit for the communication with the security system, wherein the module unit is configured in such a way that the communication can be performed by means of a wideband communication method.
